(19) United States
(12) Patent Application Publication
(10) Pub. No.: US 2025/0286159 A1
(43) Pub. Date: Sep. 11, 2025

(54) SYSTEMATIC AUTO WATERING (SAW)

(71) Applicant: The Boeing Company, Arlington, VA (US)

(72) Inventors: Dustin P. Greene, Aledo, TX (US); John M. Holder, Plano, TX (US)

(21) Appl. No.: 18/601,974

(22) Filed: Mar. 11, 2024

(51) Int. Cl. H01M 10/48; H01M 50/682

(52) U.S. Cl. CPC H01M 10/484; H01M 10/488; H01M 50/682; H01M 2220/20

(57) ABSTRACT

A systematic automatic watering system tool is described. In one embodiment, a systematic automatic battery watering system tool includes a non-contact electrolyte level sensing probe. The probe includes an insertion stop adapted to abut against an edge of a battery cell electrolyte fill port, an insertion tip comprising a fill conduit, a signal transmitting transducer, and a signal receiving transducer adapted to stop a flow of liquid into the battery cell in response to detecting a strength of a received signal reflected by a surface of an electrolyte in the battery cell exceeding a received signal strength threshold. Initially developed to water battery cells, its design versatility extends to various other applications.

### BACKGROUND INFORMATION

### 1. Field

The present disclosure relates generally to a systematic automatic watering system and systematic automatic watering system methodologies, and more specifically to a systematic automatic watering tool for battery cell electrolyte maintenance and associated methodologies.

### 2. Background

Vehicles are dependent on their batteries. Batteries deteriorate over time and need to be serviced according to manufacturer procedures in order to extend their useful lifetimes. One of the aspects of battery service is maintaining electrolyte level within specifications in each of the cells of a battery.

Typically, the battery manufacturer procedure calls for a time-consuming filling process with use of a syringe to maintain electrolyte level. Drawbacks to this approach are lack of precision and unpredictable productivity. Other competitor solutions are very inaccurate and miss aspects of compliance.

One previous approach to maintaining electrolyte level within each of the cells of a battery uses a vacuum pump and a pressure sensor. During watering when liquid is added to raise the electrolyte level, the rising electrolyte eventually touches a vacuum system orifice causing the pressure sensor to detect a pressure drop. Consequently, a relay can be used to shut off the flow of water.

However, a significant drawback to this previous approach is that before every shut-off some corrosive electrolyte is drawn into the vacuum system through the orifice. The problems inherent with this previous approach are related to corrosion and inconsistency. Because a vacuum is used to make contact with rising electrolyte, corrosive potassium hydroxide electrolyte is introduced to the internals of the system. This causes false pressure reading over time leading to inconsistency. Eventually, corrosion degrades the vacuum system, especially the conduit defining the orifice, leading to absence of precision and even contamination of the electrolyte. Ultimately, systems that implement this previous approach inevitably fail before the end of their theoretical life cycle. Another significant drawback to this contact approach is cross-contamination of electrolyte between cells.

Therefore, it would be desirable to have a watering system tool, as well as methods of using that tool that take into account at least some of the issues discussed above, as well as other possible issues.

### SUMMARY

There is a need for the following embodiments of the present disclosure. Of course, the present disclosure is not limited to these embodiments.

Embodiments of the present disclosure can provide a systematic non-contact automatic battery watering system tool and methodology. No corrosive electrolytes or other solutions enter the system alleviating failure problems and providing a significant commercial advantage.

An embodiment of the present disclosure provides a method of automatically watering a battery cell, comprising: providing a systematic automatic battery watering system tool comprising a non-contact electrolyte level sensing probe comprising an insertion stop adapted to abut against an edge of a battery cell electrolyte fill port, and an insertion tip comprising a fill conduit, a signal transmitting transducer, and a signal receiving transducer; introducing the insertion tip into the battery cell electrolyte fill port; abutting the insertion stop against the edge of the battery cell electrolyte fill port; starting a flow of a liquid through the fill conduit and into the battery cell; emitting a transmitted signal using the signal transmitting transducer; monitoring a strength of a received signal reflected by a surface of an electrolyte in the battery cell using the signal receiving transducer; detecting the strength of the received signal reflected by the surface of the electrolyte in the battery cell exceeding a received signal strength threshold; and stopping the flow of the liquid into the battery cell.

Another embodiment of the present disclosure provides an apparatus for automatically watering a battery cell, comprising: a control panel; a non-contact electrolyte level sensing probe coupled to the control panel, the non-contact electrolyte level sensing probe comprising: an insertion stop adapted to abut against an edge of a battery cell electrolyte fill port; an insertion tip comprising a fill conduit; a signal transmitting transducer; and a signal receiving transducer adapted to stop a flow of liquid into the battery cell in response to detecting a strength of a received signal reflected by a surface of an electrolyte in the battery cell exceeding a received signal strength threshold.

Another embodiment of the present disclosure provides a method of automatically watering, comprising: providing a systematic automatic watering system tool comprising a non-contact liquid level sensing probe comprising an insertion stop adapted to abut against an edge of a cell fill port, and an insertion tip comprising a fill conduit, a signal transmitting transducer, and a signal receiving transducer; setting a received signal strength threshold based on a predetermined set point associated with a type of cell characteristic of a cell; introducing the insertion tip into the cell fill port of the cell; closing a contact switch located on the non-contact liquid level sensing probe and adapted to operatively cooperate with the cell fill port when abutting the insertion stop against the edge of the cell fill port to enable starting a flow of a liquid; abutting the insertion stop against the edge of the cell fill port; starting a flow of a liquid through the fill conduit and into the cell; emitting a transmitted signal using the signal transmitting transducer; monitoring a strength of a received signal reflected by a surface of a liquid in the cell using the signal receiving transducer; detecting the strength of the received signal reflected by the surface of the liquid in the cell exceeding the received signal strength threshold; and stopping the flow of the liquid into the cell.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an apparatus comprising an systematic automatic watering system in accordance with an illustrative embodiment;

FIG. 2 is an illustration of a non-contract electrolyte level sensing probe for a systematic automatic watering system in accordance with an illustrative embodiment;

FIG. 3 is an illustration of a control panel for a systematic automatic watering system in accordance with an illustrative embodiment;

FIG. 4 is an illustration of a flowchart of a process for systematic automatic battery watering in accordance with an illustrative embodiment;

FIG. 5 is an illustration of a flowchart of a process for scanning a code located on a battery cell and setting a received signal strength threshold based on a predetermined set point associated with a type of cell characteristic of the battery cell in accordance with an illustrative embodiment;

FIG. 6 is an illustration of a flowchart of a process for closing a contact switch, opening the contact switch, and shutting off a flow of liquid in accordance with an illustrative embodiment;

FIG. 7 is an illustration of a flowchart of a process for monitoring a received signal using a photoelectric device in accordance with an illustrative embodiment;

FIG. 8 is an illustration of a flowchart of a process for monitoring a received signal using a sonar sensor in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well-known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

An embodiment of this disclosure includes a systematic automatic watering system tool and methodology. In this embodiment, a readily commercially available industrial PLC (programmable logic controller) can be utilized for the logic together with a readily commercially available lab accurate flow sensor, and combined with multiple level sensing guns (level sensing probes) corresponding to multiple battery cell form factors. The PLC programing can adapt to differences in batteries and automatically store cell watering characterization data for compliance. The individual cells if provided with bar codes can be scanned by the program ensuring no user error when setting up the system for use.

Commercially available PLCs are updatable in the future to allow continued use in watering batteries, no matter the changes made to the cells of the batteries by manufacturers. No corrosive solutions enter the system alleviating failure problems and providing a significant commercial advantage.

In a first example, an embodiment of the systematic automatic watering system uses a non-contact laser to reflect off the top of the water in an electrolyte. The analog output is based off the intensity of the diffused light. The use of a photodetector in combination with a data look up table of different threshold intensities for different types of batteries (e.g. per battery part number) or different types of individual cell part numbers ensures the resulting fill level is correct, even between different size cells and accounting for vent access.

In a second example, an embodiment of the systematic automatic watering system uses a non-contact sonar signal to bounce off the top of the water. The analog output is based off the time it takes for the sound to return to the sensor. Again, the use of an acoustic sensor in combination with a database of different sound/time thresholds for different batteries or cells (e.g. per battery part number or individual cell part number) to ensure the liquid level is correct between different size cells and accounting for vent access.

It is important to note that the electrolyte (e.g. potassium hydroxide) does not come in contact with the probe (gun). Consequently, a much more reliable level of electrolyte filling is provided by the system tool and methodology, and a much longer longevity of the tool is provided.

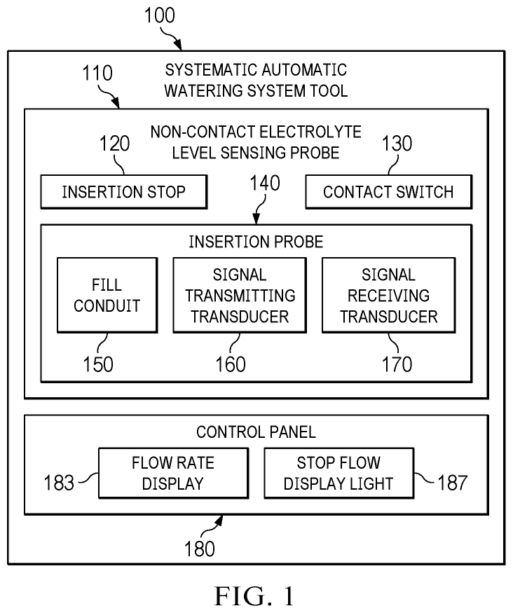

Turning now to FIG. 1, an illustration of a block diagram of a systematic automatic watering system tool 100 is depicted in accordance with an illustrative embodiment. The phrase systematic automatic watering can be abbreviated with the acronym SAW. The systematic automatic watering system tool 100 comprises a non-contact electrolyte level sensing probe 110. The non-contact electrolyte levels sensing probe 110 includes an insertion stop 120 the non-contact electrolyte level sensing probe 110 includes a contact switch 130.

The non-contact electrolyte level sensing probe 110 includes an insertion probe 140. The insertion probe 140 includes a fill conduit 150. The insertion probe 140 includes a signal transmitting transducer 160. The insertion probe 140 includes a signal receiving transducer 170. The signal transmitting transducer can include an acoustic transmitter and/or an optical transmitter and the signal receiving transducer can include an acoustic receiver and/or an optical receiver.

This systematic automatic watering system tool 100 includes a control panel 180. The control panel 180 includes a flow rate display 183. The control panel 180 includes a stop flow display light 187. An aircraft battery servicing machine can include the insertion probe and/or the control panel.

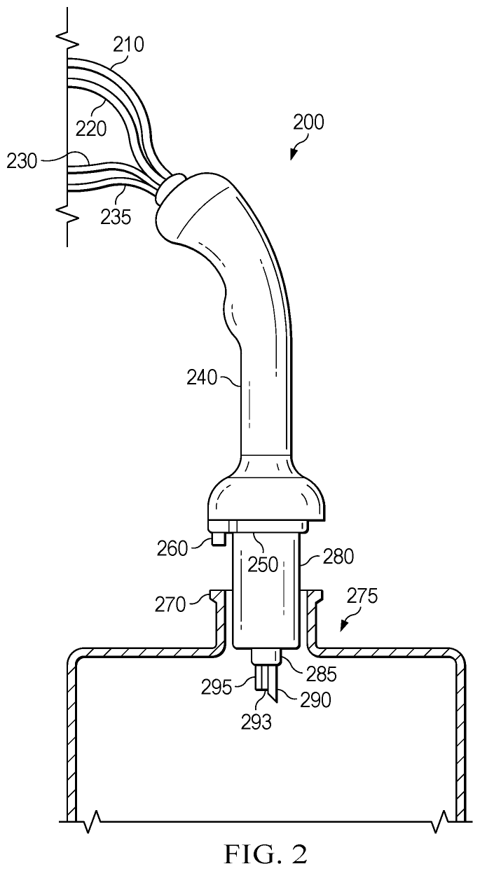

Referring to FIG. 2, a non-contact electrolyte level sensing probe 200 of a systematic automatic watering system tool is shown. Non-contact electrolyte level sensing probe 200 includes an electrolyte supply hose 210 and a signal transmitting cable 220. The non-contact electrolyte level sensing probe 200 includes a signal receiving cable 230. The non-contact electrolyte level sensing probe 200 includes a contact switch signal cable 235. Of course, embodiments of this disclosure are not limited to the depicted configuration of hose and cables. In particular, alternative embodiments can combine the signal receiving cable and the signal transmitting cable into a single cable by separating the transmitting signal and the receiving signal across multiple conductors within the single cable or by signal separation on a single circuit.

The non-contact electrolyte level sensing probe 200 is advantageously configured to have an ergonomically shaped handle 240. The non-contact electrolyte level sensing probe 200 includes an insertion stop 250 configured to make contact with a flange 270 of an electrolyte fill port 275 of a battery cell. The insertion stop 250 includes a contact switch 260. The contact switch 260 is configured to be actuated by being depressed by contact with flange 270 of electrolyte fill port 275. This actuation can send a signal to a control panel that the non-contact electrolyte level sensing probe 200 is located at a fixed location relative to flange 270 of electrolyte fill port 275. Thus, the tip of the non-contact electrolyte level sensing probe 200 will be a fixed distance beneath the flange 270.

The non-contact electrolyte level sensing probe 200 includes an insertion tip 280. The insertion tip 280 is configured to present an open end of an insertion conduit 285 within the battery cell The insertion tip 280 includes and the insertion conduit 285 at least partially surrounds an electrolyte supply tip 290. The electrolyte supply tip 290 is advantageously configured to include an angular orifice 291 to help direct the flow of electrolyte fluid.

The insertion tip 280 includes and the insertion conduit 285 at least partially surrounds a signal transmitting transducer 293. The insertion tip 280 includes and the insertion conduit 285 at least partially surrounds a signal receiving transducer 295. Of course, embodiments of this disclosure are not limited to the depicted configuration of components. In particular, the electrolyte supply tip, the signal transmitting transducer, and the signal receiver can be rearranged or even combined in fewer, or in a unitary structure. Also, there can be additional subcomponents located on the insertion conduit such as additional transducers, sensors and other subcomponents.

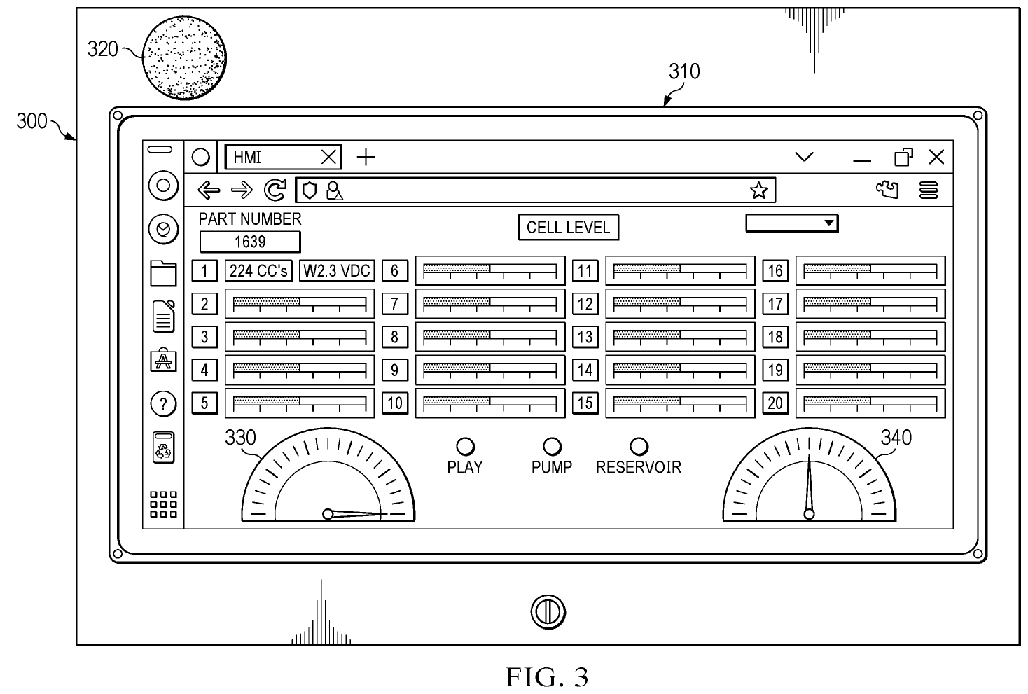

Referring to FIG. 3, a control panel 300 of a systematic automatic watering system tool is shown. The control panel 300 includes a touch screen 310. The control panel 300 includes a flow stopped indicator 320. The flow stopped indicator 320 can include a large red light.

The touch screen 310 includes a flow rate indicator 330. The touch screen 310 includes a reservoir level indicator 340. Of course, the invention is not limited to the control panel or touch screen of this embodiment, and alternative embodiments can include alternative control panels and/or alternative touch screens with alternative controls.

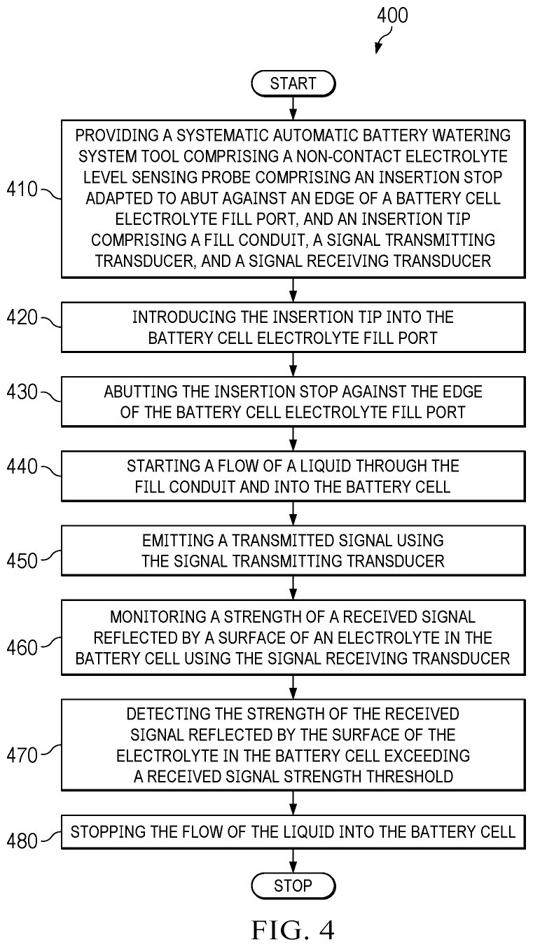

Referring to FIG. 4, a process for systematic automatic battery watering is shown. Block 410 includes providing a systematic automatic battery watering system tool comprising a non-contact electrolyte level sensing probe comprising an insertion stop adapted to abut against an edge of a battery cell electrolyte fill port, and an insertion tip comprising a fill conduit, a signal transmitting transducer, and a signal receiving transducer. Block 420 includes introducing the insertion tip into the battery cell electrolyte fill port. Block 430 includes abutting the insertion stop against the edge of the battery cell electrolyte fill port. Block 440 includes starting a flow of a liquid through the fill conduit and into the battery cell. Block 450 includes emitting a transmitted signal using the signal transmitting transducer. Block 460 includes monitoring a strength of a received signal reflected by a surface of an electrolyte in the battery cell using the signal receiving transducer. Block 470 includes detecting the strength of the received signal reflected by the surface of the electrolyte in the battery cell exceeding a received signal strength threshold. Block 480 includes stopping the flow of the liquid into the battery cell.

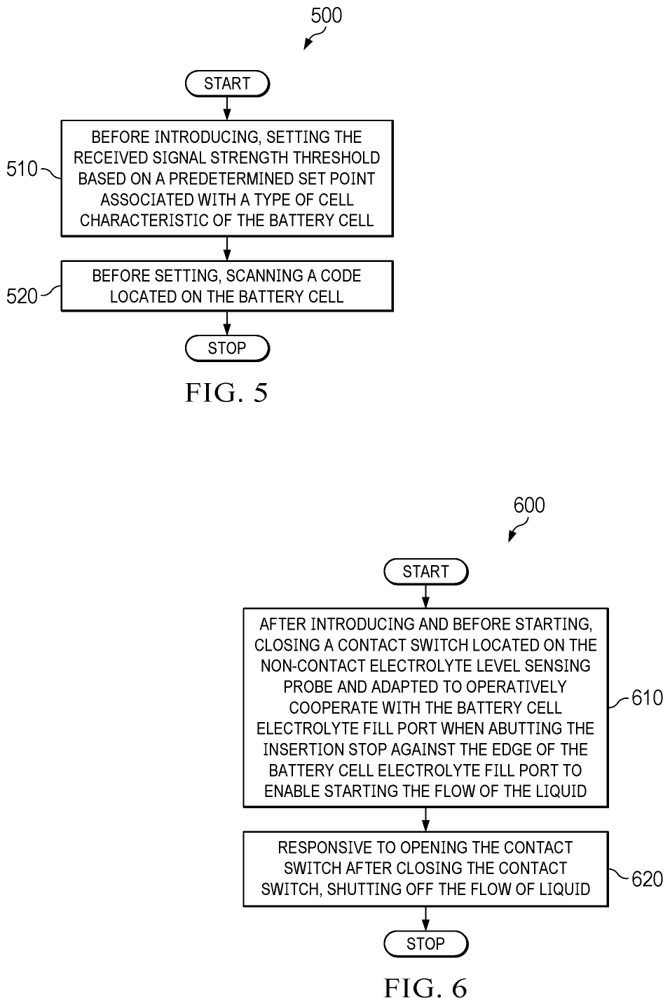

Referring to FIG. 5, a process for scanning a bar code or QR code located on a battery cell and setting a received signal strength threshold based on a predetermined set point associated with a type of cell characterized by the bar code or QR code located on the battery cell is shown. Block 510 includes, before introducing, setting the received signal strength threshold based on a predetermined set point associated with a type of cell characteristic of the battery cell. Block 520 includes, before setting, scanning a code located on the battery cell.

Referring to FIG. 6, a process for closing a contact switch, opening the contact switch, and shutting off a flow of liquid is shown. Block 610 includes, after introducing and before starting, closing a contact switch located on the non-contact electrolyte level sensing probe and adapted to operatively cooperate with the battery cell electrolyte fill port when abutting the insertion stop against the edge of the battery cell electrolyte fill port to enable starting the flow of the liquid. Block 620 includes, responsive to opening the contact switch after closing the contact switch, shutting off the flow of liquid.

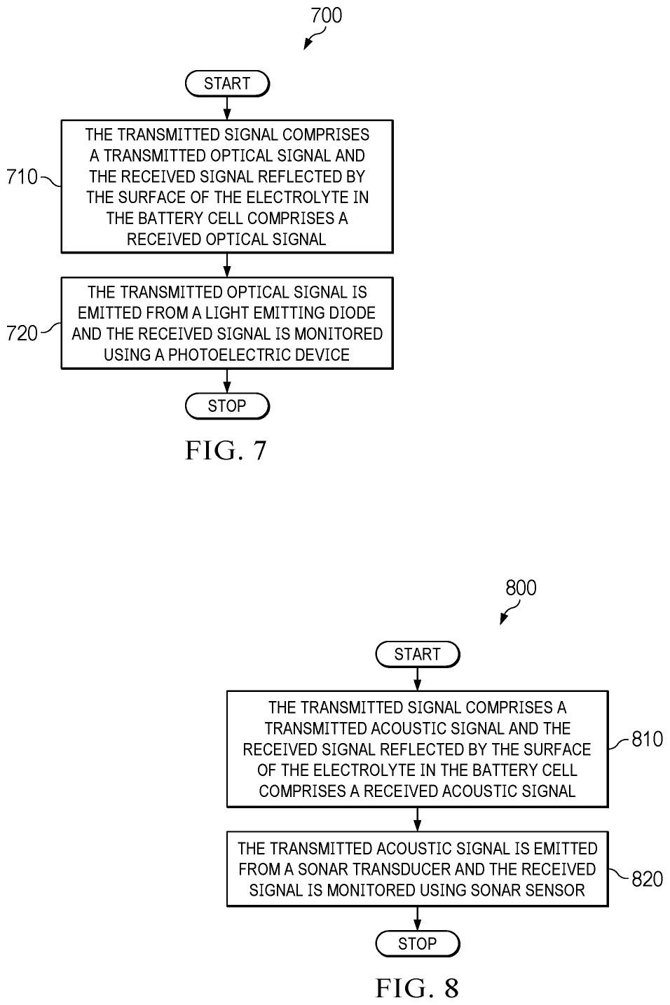

Referring to FIG. 7, a process for monitoring a received optical signal using a photoelectric device is shown. Block 710 depicts an aspect of an embodiment where the transmitted signal comprises a transmitted optical signal and wherein the received signal reflected by the surface of the electrolyte in the battery cell comprises a received optical signal. Block 720 depicts an aspect of an embodiment where the transmitted optical signal is emitted from a light emitting diode and the received signal is monitored using a photoelectric device.

Referring to FIG. 8, a process for monitoring a received acoustic signal using a sonar sensor is shown. Block 810 depicts an aspect of an embodiment where the transmitted signal comprises a transmitted acoustic signal and wherein the received signal reflected by the surface of the electrolyte in the batter cell comprises a received acoustic signal. Block 820 depicts an aspect of an embodiment where the transmitted acoustic signal is emitted from a sonar transducer and the received signal is monitored using sonar sensor.

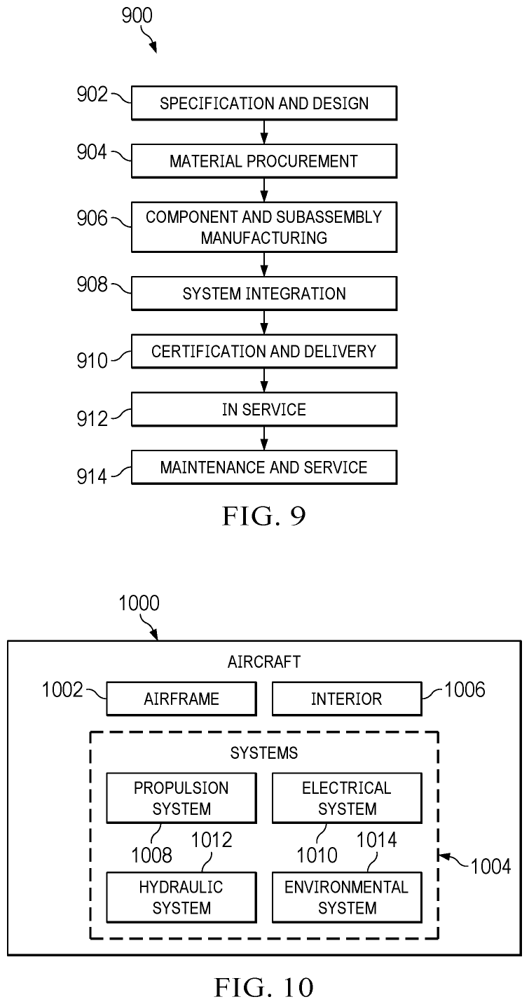

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in the form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of automatically watering a battery cell, comprising:
providing a systematic automatic battery watering system tool comprising a non-contact electrolyte level sensing probe comprising an insertion stop adapted to abut against an edge of a battery cell electrolyte fill port, and an insertion tip comprising a fill conduit, a signal transmitting transducer, and a signal receiving transducer;
introducing the insertion tip into the battery cell electrolyte fill port;
abutting the insertion stop against the edge of the battery cell electrolyte fill port;
starting a flow of a liquid through the fill conduit and into the battery cell;
emitting a transmitted signal using the signal transmitting transducer;
monitoring a strength of a received signal reflected by a surface of an electrolyte in the battery cell using the signal receiving transducer;
detecting the strength of the received signal reflected by the surface of the electrolyte in the battery cell exceeding a received signal strength threshold; and
stopping the flow of the liquid into the battery cell.

2. The method of claim 1, further comprising, before introducing, setting the received signal strength threshold based on a predetermined set point associated with a type of cell characteristic of the battery cell.

3. The method of claim 2, further comprising, before setting, scanning a code located on the battery cell.

4. The method of claim 1, further comprising, after introducing and before starting, closing a contact switch located on the non-contact electrolyte level sensing probe and adapted to operatively cooperate with the battery cell electrolyte fill port when abutting the insertion stop against the edge of the battery cell electrolyte fill port to enable starting the flow of the liquid.

5. The method of claim 4, further comprising, responsive to opening the contact switch after closing the contact switch, shutting off the flow of liquid.

6. The method of claim 1, wherein the transmitted signal comprises a transmitted optical signal and wherein the received signal reflected by the surface of the electrolyte in the battery cell comprises a received optical signal.

7. The method of claim 6, wherein the transmitted optical signal is emitted from a light emitting diode and the received signal is monitored using a photoelectric device.

8. The method of claim 1, wherein the transmitted signal comprises a transmitted acoustic signal and wherein the received signal reflected by the surface of the electrolyte in the batter cell comprises a received acoustic signal.

9. The method of claim 8, wherein the transmitted acoustic signal is emitted from a sonar transducer and the received signal is monitored using sonar sensor.

10. An aircraft battery comprising a cell watered using the method of claim 6.

11. An apparatus for automatically watering a battery cell, comprising:
a control panel;
a non-contact electrolyte level sensing probe coupled to the control panel, the non-contact electrolyte level sensing probe comprising:
an insertion stop adapted to abut against an edge of a battery cell electrolyte fill port;
an insertion tip comprising a fill conduit;
a signal transmitting transducer; and
a signal receiving transducer adapted to stop a flow of liquid into the battery cell in response to detecting a strength of a received signal reflected by a surface of an electrolyte in the battery cell exceeding a received signal strength threshold.

12. The apparatus of claim 11, wherein the control panel comprises a flow rate display.

13. The apparatus of claim 11, wherein the control panel comprises a stop flow display light.

14. The apparatus of claim 11, further comprising a contact switch located on the non-contact electrolyte level sensing probe and adapted to operatively cooperate with a battery cell electrolyte fill port when abutting the insertion stop against the edge of the battery cell electrolyte fill port to enable starting the flow of the liquid.

15. The apparatus of claim 11, wherein the signal transmitting transducer comprises an optical transmitter and the signal receiving transducer comprises an optical receiver.

16. The apparatus of claim 15, wherein the optical transmitter comprises a light emitting diode and the optical receiver comprises a photoelectric device.

17. The apparatus of claim 11, wherein the signal transmitting transducer comprises an acoustic transmitter and the signal receiving transducer comprises an acoustic receiver.

18. The apparatus of claim 17, wherein the acoustic transmitter comprises a sonar transducer and the acoustic receiver comprises a sonar sensor.

19. An aircraft battery servicing machine comprising the apparatus of claim 11.

20. A method of automatically watering, comprising:
providing a systematic automatic watering system tool comprising a non-contact liquid level sensing probe comprising an insertion stop adapted to abut against an edge of a cell fill port, and an insertion tip comprising a fill conduit, a signal transmitting transducer, and a signal receiving transducer;
setting a received signal strength threshold based on a predetermined set point associated with a type of cell characteristic of a cell;
introducing the insertion tip into the cell fill port of the cell;
closing a contact switch located on the non-contact liquid level sensing probe and adapted to operatively cooperate with the cell fill port when abutting the insertion stop against the edge of the cell fill port to enable starting a flow of a liquid;
abutting the insertion stop against the edge of the cell fill port;
starting a flow of a liquid through the fill conduit and into the cell;
emitting a transmitted signal using the signal transmitting transducer;
monitoring a strength of a received signal reflected by a surface of a liquid in the cell using the signal receiving transducer;
detecting the strength of the received signal reflected by the surface of the liquid in the cell exceeding the received signal strength threshold; and
stopping the flow of the liquid into the cell.
